(19) United States
(12) Patent Application Publication
(10) Pub. No.: US 2022/0046110 A1
(43) Pub. Date: Feb. 10, 2022

(54) VIRTUAL DATASET MANAGEMENT DATABASE SYSTEM

(71) Applicant: Salesforce.com, Inc., San Francisco, CA (US)

(72) Inventors: Chi WANG, Redmond, WA (US); Linwei ZHU, San Francisco, CA (US); Hsiang-Yun LEE, Palo Alto, CA (US); Gopi Krishnan NAMBIAR, San Francisco, CA (US)

(73) Assignee: Salesforce.com, Inc., San Francisco, CA (US)

(21) Appl. No.: 16/985,324

(22) Filed: Aug. 5, 2020

(51) Int. Cl. H04L 29/08; G06K 9/62; G06F 12/0893

(52) U.S. Cl. CPC H04L 67/34; G06F 12/0893; G06K 9/6231; G06K 9/6257

(57) ABSTRACT

A request to access a virtual dataset identifying one or more changeset selection criteria may be received. One or more changesets may be selected based on the selection criteria. Each changeset may correspond with a point in time and may include data references to data items added to the virtual dataset at the point in time. A learning dataset that includes a plurality of data items may be identified.

### FIELD OF TECHNOLOGY

This patent document relates generally to database systems and more specifically to virtual dataset management in a database system.

### BACKGROUND

Machine learning models are trained with stationary batches of data, but the world is constantly changing. Because trained models must frequently perform well in a dynamic environment, datasets are often incrementally updated from non-stationary data sources to keep the training data updated. Machine learning is also an iterative process involving repeated cycles of training and testing. Comparing the datasets in successive training runs can reveal important details that can be critical for troubleshooting.

“Cloud computing” may be used to store datasets that are employed for tasks such as machine learning. Cloud computing services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

The ingestion and storage of datasets can create significant challenges related to, for example, version control. When datasets are stored as, for instance, large groups of binary files that are periodically supplemented with new data, efficiently recovering the dataset used to train a previous version of a model can be quite difficult. Accordingly, improved techniques for dataset management are desired.

### BRIEF DESCRIPTION OF THE DRAWINGS

The included drawings are for illustrative purposes and serve only to provide examples of possible structures and operations for the disclosed inventive systems, apparatus, methods and computer program products for virtual dataset management. These drawings in no way limit any changes in form and detail that may be made by one skilled in the art without departing from the spirit and scope of the disclosed implementations.

FIG. 1 illustrates an example of a virtual dataset lifecycle method, performed in accordance with one or more embodiments.

FIG. 2 illustrates an example of a data ecosystem, configured in accordance with one or more embodiments.

FIG. 3 illustrates an example of a virtual dataset, configured in accordance with one or more embodiments.

FIG. 4 illustrates an example of a virtual dataset lifecycle, organized in accordance with one or more embodiments.

FIG. 5 illustrates an example of a virtual dataset creation method, performed in accordance with one or more embodiments.

FIG. 6 illustrates an example of a virtual dataset ingestion method, performed in accordance with one or more embodiments.

FIG. 7 illustrates an example of a virtual dataset access method, performed in accordance with one or more embodiments.

FIG. 8 shows a block diagram of an example of an environment that includes an on-demand database service configured in accordance with some implementations.

FIG. 9A shows a system diagram of an example of architectural components of an on-demand database service environment, configured in accordance with some implementations.

FIG. 9B shows a system diagram further illustrating an example of architectural components of an on-demand database service environment, configured in accordance with some implementations.

FIG. 10 illustrates one example of a computing device, configured in accordance with one or more embodiments.

### DETAILED DESCRIPTION

Artificial intelligence and machine learning practitioners generally agree that the large majority of time in a machine learning project is occupied with dataset ingestion, processing, cleansing, and management. Although data collection tools are well developed, dataset management has received much less attention. Nevertheless, dataset management is a crucial part of data analytics, and presents unique technological problems.

For example, machine learning training is data driven. Each model is trained with stationary batches of data, but the world is constantly changing. Many trained models need to perform well in a dynamic environment, which implies that incrementally available data from non-stationary data sources needs to be absorbed and incorporated into the training data in order to keep the training data in an updated state.

Machine learning is also an iterative process. A model is trained and retrained, with model performance observed after each iteration and compared across different training runs. Such comparisons can be critical for troubleshooting. However, many training datasets are composed of a large collection of files (e.g., binary files), and different model versions are trained on different combinations of those files. Versioning different groups of files and retrieving those files for a particular version thus presents a unique challenge, particularly when the underlying pool of available training data is itself updated over time.

Moreover, some data is highly sensitive and accessible only under strict access control requirements. For instance, customer sales records, payment records, health records, tax records, and other such data is highly sensitive. However, training systems normally operate in a relatively insecure environment. Lax security often makes it difficult or impossible to train models using valuable but highly sensitive datasets.

A machine learning system may be shared by potentially many different users spread across potentially many different organizations. Some datasets may be shared across multiple users and/or multiple organizations. However, many datasets may be private. Accordingly, access to a dataset needs to be restricted to authorized parties.

As the volume of data increases, so too does the set of available data collectors and data analytics tools. When datasets are managed in a one-off, individualized way, dataset management and versioning introduces significant complexity into both data acquisition and downstream model training components.

Techniques and mechanisms described herein provide for an data management system based on the idea of a virtual dataset. According to various embodiments, a virtual dataset provides a single location for storing the potentially many individual data items that may be used in a data analytics context. Ingested data is incorporated into the virtual dataset and tracked using successive changesets. A data consumer may then query the virtual dataset to retrieve data items for analysis.

According to various embodiments, techniques and mechanisms described herein provide for a dataset management approach based on encapsulation. The dataset management system encapsulates details such as data sources, data analytics tools, data types, and other such complexity. Access to the data may then be provided via, for example, a simple application procedure interface (API).

According to various embodiments, techniques and mechanisms described herein provide for a scalable dataset management system. Scalability is particularly important in machine learning contexts such as distributed training and hyper parameter training. In various configurations described herein, data acquisition, management, and retrieval performance does not appreciably degrade as data volume and/or request volume increases.

Consider the example of Alexandra. Alexandra is assigned an object detection training task: training a model to recognize the trademark of an insurance company “LifeA”. At the beginning, Alexandra collected some trademark (TM1) images from LifeA to build a dataset named “lifeA_trademark_tm1.zip”, which Alexandra used to train a model. Eventually, “LifeA” launched two new trademarks (TM2 and TM3). To adapt that change, Alexandra built a new dataset “lifeA_trademark_tm1_tm2_tm3.zip”, which contains all three kinds of trademark images. Then LifeA lost a lawsuit and was required to yield its trademark tm2 to a competitor. To reflect this new change, Alexandra had to build another dataset, “lifeA_trademark_tm1_tm3.zip”, that excludes tm2 images. Later, when LifeA is about to release a new trademark tm4, its trademark design department refused Alexandra's access request to their datastore due to security concerns. Despite not having access to tm4 images, Alexandra needs to update her trademark recognition model to recognize trademark tm4. In this example, Alexandra has to produce three different datasets (lifeA_trademark_tm1.zip, lifeA_trademark_tm1_tm2_tm3.zip, and lifeA_trademark_tm1_tm3.zip). These training files are correlated and include many duplicate data items. Nevertheless, dataset management work occupies an increasingly large portion of Alexandra's time as more changes are made. For instance, creating a new dataset that contains only trademark tm2 and tm4 would involve performing a file comparison among the existing datasets. Another problem is the proper labeling of datasets, which becomes particularly difficult when a project is shared among multiple people and/or multiple teams.

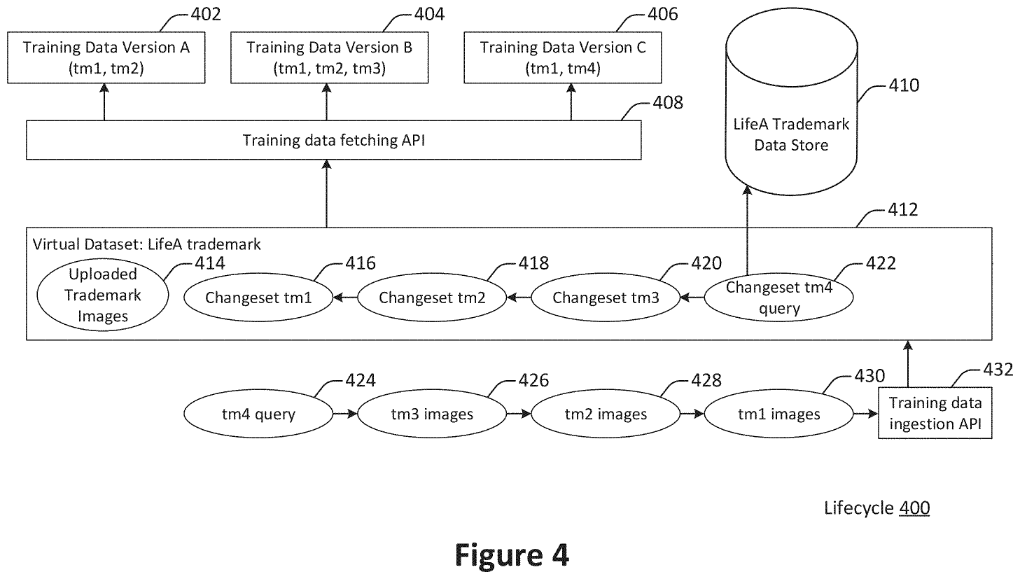

In contrast to these conventional techniques, techniques and mechanisms described herein provide for a streamlined, straightforward approach to dataset management. An application of these techniques and mechanisms to Alexandra's problem is discussed in more detail with respect to the virtual dataset lifecycle 400 shown in FIG. 4.

In some implementations, techniques and mechanisms described herein facilitate the comparison of current and previous machine learning models to identify the cause of differences in model performance. For instance, the data items used to train different versions of a machine learning model may be separately retrieved and analyzed upon request.

In some embodiments, techniques and mechanisms described herein facilitate the reversion of data updates in a dataset, for instance if they are made by mistake. For example, a changeset referencing mistakenly added data items may be deleted. Alternatively, the changeset may simply not be selected when creating a learning dataset from the virtual dataset. These approaches are superior to existing version control techniques such as GIT, which function poorly for large files and binary files.

In some embodiments, techniques and mechanisms described herein may provide for dataset versions based on user requests rather than actual files. Each learning dataset may be versioned by, for example, hashing a data query, hashing a set of changesets retrieved by a query, and/or hashing a set of parameters associated with a data query. In this way, learning dataset versions may be created much more quickly than separately hashing each file included in a learning dataset.

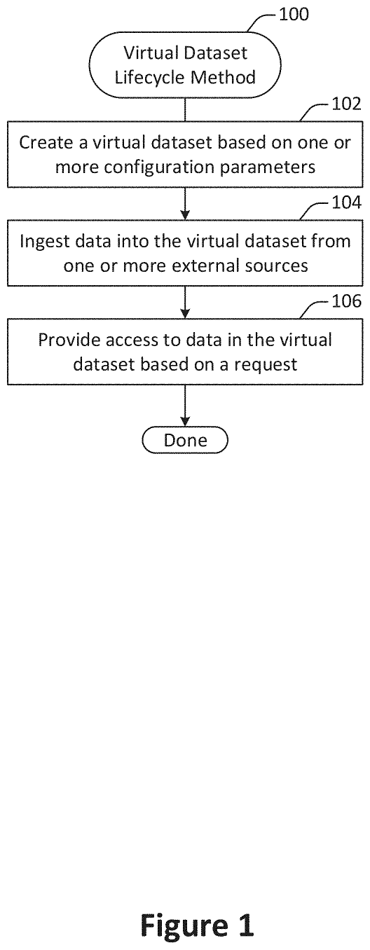

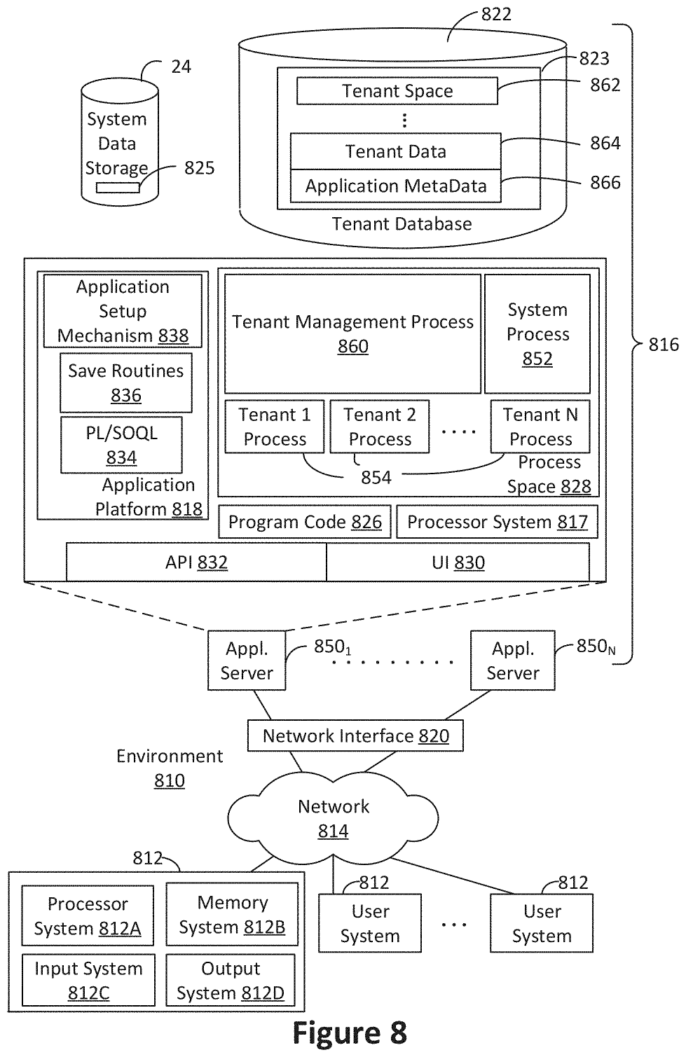

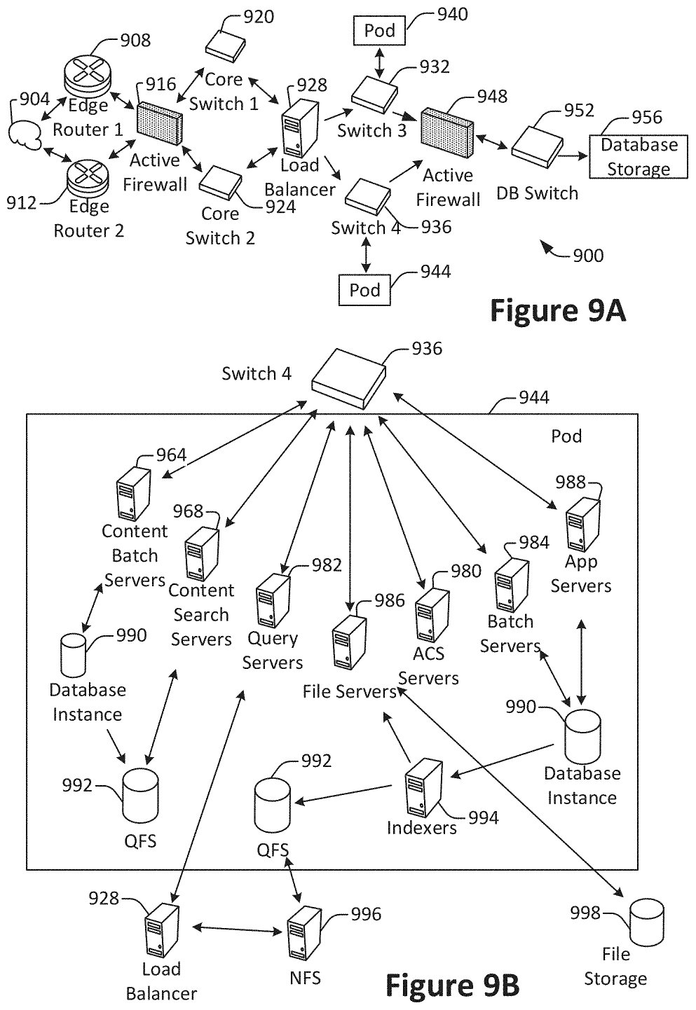

FIG. 1 illustrates an example of a virtual dataset lifecycle method 100, performed in accordance with one or more embodiments. According to various embodiments, the method 100 may be performed within an on-demand computing services environment such as the environments 810 and 900 shown in FIG. 8, FIG. 9A, and FIG. 9B.

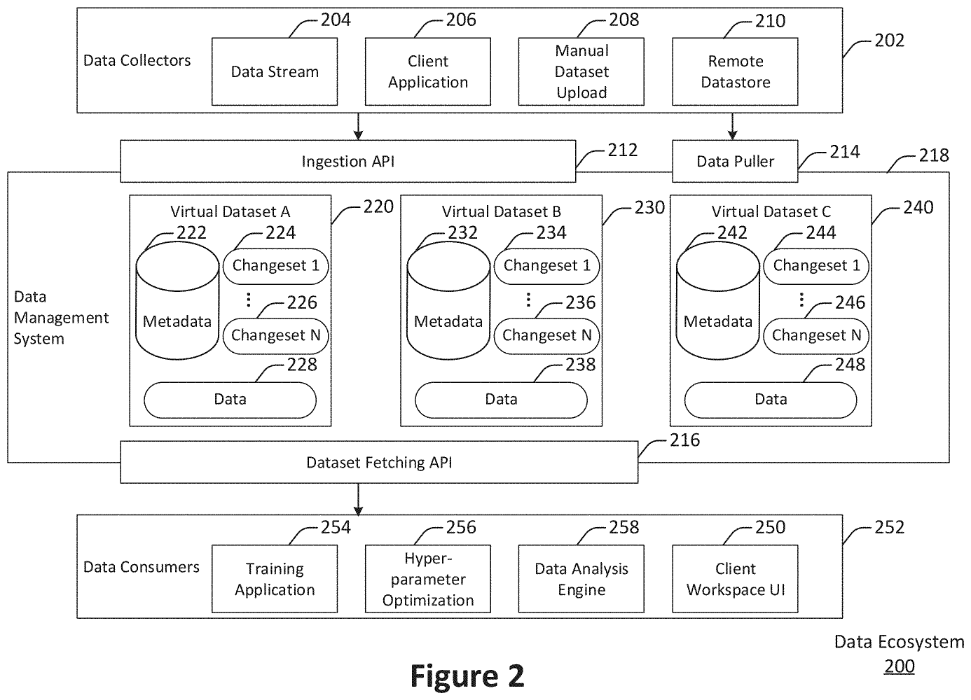

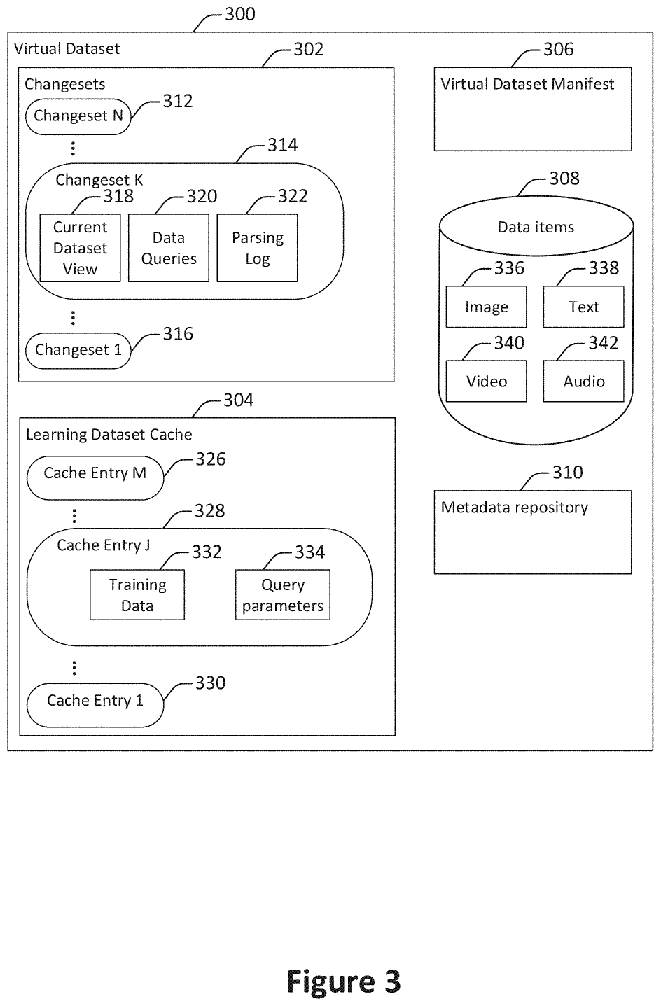

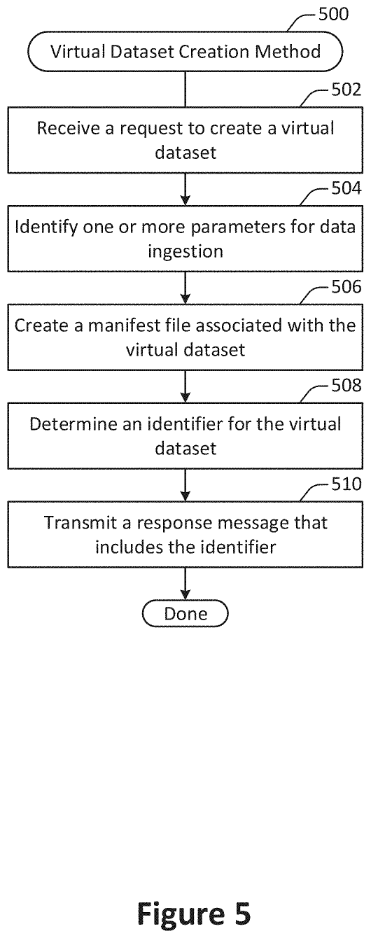

A virtual dataset is created at 102 based on one or more configuration parameters. According to various embodiments, the configuration parameters may include information such as a virtual dataset name, one or more data types, and/or one or more virtual dataset owners. The virtual dataset may be created in a virtual dataset management system such as that shown in FIG. 2. An example of a virtual dataset created according to such techniques is shown in FIG. 3. Additional details regarding the creation of a virtual dataset are described with respect to the method 500 shown in FIG. 5.

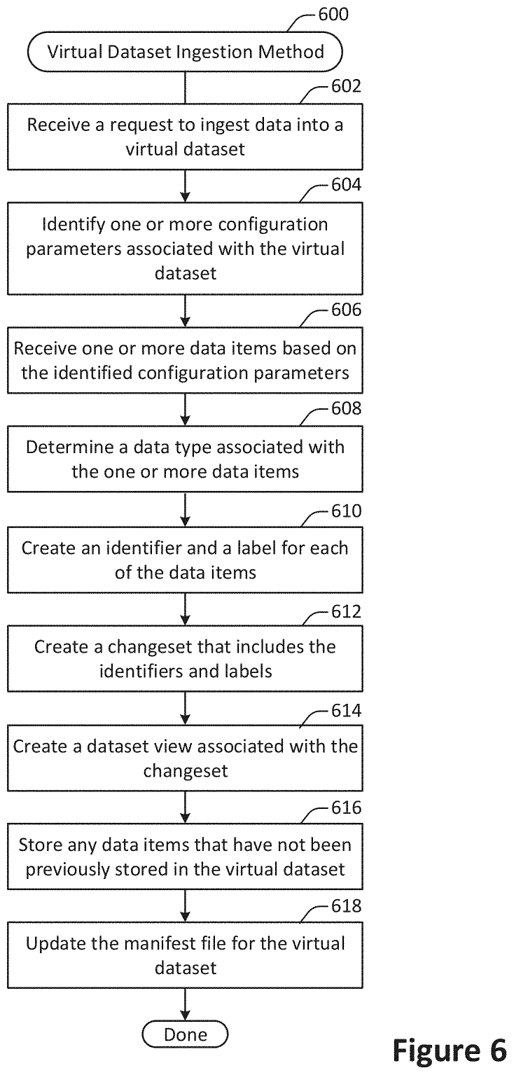

Data from one or more external sources is ingested into the virtual dataset at 104. According to various embodiments, ingesting data into the dataset may involve one or more data retrieval operations performed via a network. For example, data may be retrieved via a RESTful interface using a push operation, a pull operation, or some combination thereof. Ingesting data may involve operations such as identifying a data type, indexing ingested data, deduplicating ingested data, and constructing one or more change sets characterizing changes in the data that has been ingested. Additional details regarding the ingestion of data into a virtual dataset are described with respect to the method 600 shown in FIG. 6.

Access to data in the virtual dataset is provided at 106 based on a request. According to various embodiments, providing access to data in the virtual dataset may involve parsing a request to identify one or more changesets to which access is requested. The selected changesets may then be used to identify specific data items to include in a training dataset. The identified data items may be retrieved, combined, and provided to a data consumer. Additional details regarding providing access to a virtual dataset are described with respect to the method 600 shown in FIG. 6.

FIG. 2 illustrates an example of a data ecosystem 200, configured in accordance with one or more embodiments. The data ecosystem 200 illustrates an overall configuration in which a data management system may be employed in accordance with one or more implementations.

The data ecosystem 200 includes one or more data collectors 202. Each data collector represents a source from which data may be retrieved for ingestion into a virtual dataset. For example, the data collectors 202 include a data stream 204, a client application 206, a manual dataset upload 208, and a remote datastore 210. However, other configurations may include various types and numbers of data collectors.

According to various embodiments, a data stream 204 is a set of extracted information from a data provider. For example, a data stream 204 may include information such as user browsing data, user actions within an on-demand computing services environment, weather data, or any other incrementally updated data sources.

According to various embodiments, a client application 206 may include data derived from an application inside or outside an on-demand computing services environment. For example, a client application may provide log data.

In some implementations, a manual dataset upload 208 may be used to upload particular data items. For instance, data may be ingested via one or more archival files such as a zip file or tar archive that incorporates potentially many individual files.

In some embodiments, a remote datastore 210 may be a database, file repository, or other network-accessible location in which data is stored. A remote datastore 210 may be used to retrieve data for ingestion. Alternatively, or additionally, a remote datastore 210 may store sensitive data that is available for querying but is not to be ingested into the data management system repositories.

The data ecosystem 200 also includes one or more data consumers 252. Each data consumer represents a network-accessible destination for a learning dataset. For example, the data consumers 252 include a training application 254, a hyper parameter optimization module 256, a data analysis engine 258, and a client workspace user interface 250. However, other configurations may include various types and numbers of data consumers.

According to various embodiments, a data consumer may be a service configured to receive and apply a learning dataset, such as a machine learning model training application. Alternatively, a data consumer may be a user interface or analytics framework configured to allow a user to interact with a learning dataset, for example via data exploration.

The data ecosystem 200 also includes a data management system 218. According to various embodiments, the data management system 218 may be implemented as a service in an on-demand computing services environment. The on-demand computing services environment may be configured to provide computing services to potentially many different individuals and/or organizations via the internet.

In some embodiments, the data management system 218 may store one or more virtual datasets. For example, the data management system 218 is shown as storing the virtual dataset A 220, the virtual dataset B 230, and the virtual dataset C 240. However, in other configurations a data management system may store various numbers and types of virtual datasets.

In some implementations, the data management system 218 may be accessed via one or more APIs. For example, the data management system 218 includes an ingestion API 212, a data puller 214, and a dataset fetching API 216. However, in other configurations a data management system may include various numbers and types of APIs.

According to various embodiments, the ingestion API 212 may be used to receive data from the data collectors 202 for ingestion into a virtual dataset. The data puller 214 may be used to execute a query to retrieve data from a remote datastore such as the remote datastore 210. The dataset fetching API 216 may be used to select data for transmission to a data consumer and to transmit the selected data upon request.

In some implementations, a virtual dataset may include a metadata repository. For example, the virtual datasets shown in FIG. 2 include the metadata repositories 222, 232, and 242. Each metadata repository may store information about the data stored in the metadata repository. For instance, a metadata repository may store information such as data item labels, data item collection timestamps, and data item sources.

In some embodiments, a virtual dataset may include a data repository. For example, the virtual datasets shown in FIG. 2 include the data repositories 228, 238, and 248. Each data repository may store the individual data items included in a virtual dataset. For instance, a data repository may store information such as individual image files, video files, text documents, audio files, or other such data. In particular embodiments, each virtual dataset may be limited to a particular data type. Alternatively, a virtual dataset may be configured to store data items of different data types.

In some embodiments, a virtual dataset may include one or more changesets. For example, the virtual datasets shown in FIG. 2 include the changeset 1 224 through changeset N 226, the changeset 1 234 through changeset N 236, and the changeset 1 244 through changeset N 246. According to various embodiments, each changeset may correspond to a group of data items ingested into the changeset.

According to various embodiments, changesets may be created in a sequential manner, so that the changeset k includes data items that were ingested after the data items included in the changeset k−1. Data may be accessed by sending a request to the dataset fetching API 216 including one or more parameters identifying a virtual dataset and one or more changesets from the identified virtual dataset. Data items associated with the selected changesets may then be collected and provided to a data consumer.

In particular embodiments, a virtual dataset may be configured to store no actual data items. Instead, the virtual dataset may be composed of one or more queries or data references from a remote datastore.

FIG. 3 illustrates an example of a virtual dataset 300, configured in accordance with one or more embodiments. According to various embodiments, the virtual dataset 300 includes one or more changesets 302, a learning dataset cache 304, a virtual dataset manifest 306, a data item store 308, and one or more metadata entries 310.

According to various embodiments, the metadata repository 310 may store information about any or all of the elements associated with the virtual dataset 300. For instance, the metadata repository 310 may store information about individual data items, the virtual data manifest file, each of the one or more changesets, each of the one or more cached learning datasets, and/or any other suitable information.

In some implementations, each update operation to the virtual dataset may result in the creation of a new changeset. For example, the changesets 302 include the changeset 1 316 through the changeset N 312. Additional details are shown for an arbitrary changeset K 314.

In some embodiments, actual data items are not stored in a changeset. Instead the changeset K 314 includes one or more references to data items. Actual data items may be stored in the data item store 308.

In some embodiments, a changeset may include one or more data queries 320 instead of, or in addition to, references to data items stored in the virtual dataset. Each query may serve as a mechanism for retrieving data from one or more external data stores.

Accordingly, a query may include an address or identifier for the external data store. In addition, the query may include one or more query parameters, data item references, data collection references, or other such information for providing to the external data store in order to retrieve information from the external data store.

In some embodiments, a remote datastore query may be executed in real time, for instance during model training, and the data sent directly to a training program. In this way, the virtual dataset acts as a broker, where the changeset contains instructions for retrieving sensitive data and where the sensitive data is not stored in the virtual dataset itself. Accordingly, sensitive data is not persisted in the data store, and researchers or model developers can perform analysis and/or train models using data to which they do not have permission to access.

A changeset may include an index file 318 representing the current training data view. The index file 318 may include the references to the data items associated with the changeset. Alternatively, or additionally, the index file 318 may include or refer to the data queries 320.

In some implementations, the metadata repository 310 may be specific to the virtual dataset 300. Alternatively, metadata entries 310 may be stored in a metadata store shared by multiple virtual datasets, for instance a metadata store associated with the on-demand computing services environment in which the dataset management service is situated.

In some embodiments, the virtual dataset manifest 306 may include a description of and/or references to one or more items included in the virtual dataset 300. For instance, the virtual dataset manifest 306 may include a description of and/or references to changesets, learning dataset cache entries, and/or data items.

In some embodiments, data items may be stored in a data item store 308. For example, a data item store 308 may store one or more images 336, text passages 338, video files 340, and/or audio files 342. As another example, the data item store 308 may store one or more other types of data items, such as one or more relational database files, spreadsheets, or other suitable data.

In particular embodiments, data items may be stored in a data store that is specific to a virtual dataset. However, in some configurations a single datastore may be used for more than one virtual datasets, such as different virtual datasets associated with the same organization or located within the same on-demand computing services environment.

The learning dataset cache 304 includes one or more learning datasets created based on queries of the virtual dataset 300. For example, the learning dataset cache 304 includes the cache entry 1 330 through the cache entry M 326, with additional detail shown for the cache entry J 328.

According to various embodiments, each cache entry may include one or more training data items and/or one or more query parameters. For instance, a user may send a request to retrieve data. The request may include one or more parameters for selecting changesets. The system may then select the appropriate changesets. The changesets may be used to identify and retrieve the data items from the data store 308, which are then stored as training data 332. Alternatively, or additionally, one or more data queries associated with the selected changesets may be retrieved and used to generate the query parameters 334.

In particular embodiments, each learning dataset cache entry may be stored as an archive file such as a tar or zip file. Learning datasets may then be retrieved upon request for use by a data consumer. A learning dataset may be stored indefinitely or may eventually be deleted, for instance after the passage of a designated period of time.

FIG. 4 illustrates an example of a virtual dataset lifecycle 400, organized in accordance with one or more embodiments. According to various embodiments, the virtual dataset lifecycle 400 illustrates a simple example of how embodiments of techniques and mechanisms described herein may be used to address the issues related to the example described above related to Alexandra's management of the trademark image detection data.

Alexandra may create a virtual dataset 412 for the LifeA trademark data. She may then use the training data ingestion API 432 to ingest successive sets of training images. These image sets may include in succession the tm1 images 430, the tm2 images 428, the tm3 images 426, and the tm4 query 424 used to retrieve tm4 images from a remote data store 410.

The ingested images may be stored in a data repository 414. The data repository 414 may store not only the raw image data, but also the labels. For instance, tm3 images may be identified as such in the data repository 414, as discussed with respect to the components shown in FIG. 2 and FIG. 3.

After each set of images is ingested, an associated changeset may be created. For example, the virtual dataset 412 may include a changeset tm1 416 corresponding to the first set of images, a changeset tm2 418 corresponding to the second set of images, a changeset tm3 4120 corresponding to the third set of images, and a changeset tm4 query 422 corresponding to the tm4 query 424.

A training data fetching API 408 may be used to provide access to the trademark data. Training datasets may be created depending on one or more criteria including in a request. Each training dataset may include the data referenced in one or more changesets. Data may be retrieved from the internal data repository 414 and/or one or more external data stores such as the data store 410, as appropriate. For example, the training data version A 402 includes tm1 and tm2 data from changesets 416 and 418. As another example, the training data version B 404 includes tm1, tm2, and tm3 data from changesets 416, 418, and 428. As yet another example, the training data version C 406 includes tm1 and tm4 data from changeset tm1 416 and changeset tm4 query 422. These training datasets may be provided upon request to a downstream consumer such as a machine learning model trainer.

FIG. 5 illustrates an example of a virtual dataset creation method 500, performed in accordance with one or more embodiments. According to various embodiments, the method 500 may be performed within an on-demand computing services environment such as the environments 810 and 900 shown in FIG. 8, FIG. 9A, and FIG. 9B.

A request to create a virtual dataset is received at 502. According to various embodiments, the request may be received via a standardized virtual dataset creation API. The request may be received from any of a variety of sources. For example, a user of an on-demand computing services environment may send a request to create a virtual dataset. As another example, an application may automatically create a standardized virtual dataset.

According to various embodiments, the request received at 502 may be associated with one or more authorization elements. For instance, the request may be received as part of a communication session. The request may identify one or more organizations and/or one or more users associated with the request and/or with the virtual dataset. In this way, access to the virtual database may be limited to one or more users and/or organizations.

One or more parameters for data ingestion are identified at 504. In some embodiments, the request may specify one or more parameters for virtual dataset creation. Alternatively, or additionally, one or more parameters may be associated with a user account and/or an organization within an on-demand computing services environment.

According to various embodiments, the data ingestion parameters may include any information associated with the creation and configuration of the virtual dataset. Such parameters may include, but are not limited to: one or more data types associated with data to be ingested, one or more data sources from which to ingest data, and/or one or more access control settings.

A manifest file associated with the virtual dataset is created at 506. In some implementations, the manifest file may be used to track data items stored in the virtual dataset. As discussed with respect to FIG. 3, a manifest file may store any or all of a variety of information related to data items and the virtual dataset.

An identifier for the virtual dataset is determined at 508. In some implementations, the identifier may serve as a general-purpose mechanism for accessing the virtual dataset. That is, rather than separately tracking individual data items or files that aggregate multiple data items, the virtual dataset may be accessed by specifying the identifier in an API request to the data management system. The identifier may be created using any suitable techniques, such as by generating a random or incremented number.

A response message that includes the identifier is transmitted at 510. In some implementations, the response message may be sent to the machine that transmitted the request received at 502. The request may indicate that the virtual dataset was created and provide the identifier for subsequent access to the virtual dataset.

FIG. 6 illustrates an example of a virtual dataset ingestion method, performed in accordance with one or more embodiments. According to various embodiments, the method 600 may be performed within an on-demand computing services environment such as the environments 810 and 900 shown in FIG. 8, FIG. 9A, and FIG. 9B.

A request to ingest data into a virtual dataset is received at 602. In some implementations, the request may be received via an API. For instance, the API request may identify a source for one or more data items to ingest into the virtual dataset. The API may also include an identifier associated with the virtual dataset.

In some embodiments, the request may be generated automatically. For example, the system may automatically ingest data items from a data stream at a designated time. As another example, the system may periodically check a data source to determine whether new data items are present.

One or more configuration parameters associated with the virtual dataset are identified at 604. According to various embodiments, the configuration parameters may include information such as one or more access permissions, data types, or other such information. Configuration parameters may be included in configuration information associated with the virtual dataset. Alternatively, or additionally, one or more configuration parameters may be included with the request received at 602.

In particular embodiments, a configuration parameter may identify a source from which to receive one or more data items. For instance, a configuration parameter may identify a URL or other such identifier for accessing a remote data source via the internet.

One or more data items are received at 606 based on the identified configuration parameters. In some implementations, receiving the one or more data items may involve retrieving the data items from a URL. Alternatively, or additionally, a different retrieval mechanism may be used. For instance, one or more data items may be uploaded, scraped, or pushed from a remote location.

In particular embodiments, one or more references or queries for accessing a remote datastore may be received. A reference or query may identify information that may include, but is not limited to: a URL at which a remote datastore is located, a URL at which a remote file containing a collection of data items is located, and/or one or more query parameters for providing to a remote datastore for retrieving data items.

A data type associated with the one or more data items is determined at 608. In some implementations, the data type may be determined by analyze the data items. Alternatively, or additionally, a data type may be specified in a configuration parameter. In some configurations, different data items in a collection may have different data types. Suitable data types may include, but are not limited to: audio data, text data, video data, and image data.

An identifier and a label for each of the data items is created at 610. In some implementations, the identifier may allow the data item to be referenced from other locations, such as from within a changeset. In this way, a changeset may store information such as item references and labels without including the actual data associated with each data item, keeping the size of a changeset relatively smaller than would otherwise be the case.

In particular embodiments, item labels may be retrieved with the items themselves. Alternatively, or additionally, item labels may be supplied with the request received at 602. For instance, a parameter in an API request may identify a set of items as corresponding to “tm2” or “car.”

A changeset that includes the identifiers and labels is created at 612. According to various embodiments, the changeset may include a reference to each of the newly ingested data items. The changeset may be associated with a changeset identifier. For instance, changeset identifiers may be incremented with each newly created changeset within a virtual dataset.

In particular embodiments, the structure of a changeset or of a portion of a changeset may depend on the data type. For instance, a changeset that includes references to labeled images may be structured differently from a changeset that includes references to labeled video files.

A dataset view associated with the virtual changeset is included at 614. In some implementations, the dataset view may include a cumulative list of references to data items and remote data queries in all changesets up to and including the newly created changeset. In particular embodiments, other records may be created as well. For instance, a log may be created or supplemented in order to record the actions performed during the addition of the new data items.

At 616, any data items that have not been previously stored in the virtual dataset are stored. According to various embodiments, the data items may be stored in a data store associated with the virtual dataset. Each data item may be stored at a location accessible via the identifier associated with the data item.

In particular embodiments, data items may be deduplicated upon ingestion into the virtual dataset. For example, each data item may be hashed upon ingestion, and the hash values stored along with the data items. Then, when new data items are ingested, the new data items may be hashed as well. The hash values associated with the newly ingested data items may be compared with the comparison hash values associated with previously ingested data items. Then, data items need only be stored if they have not previously been stored.

In some implementations, data item deduplication may happen prior to creating a new changeset. For instance, a data item may be added to a newly created changeset only if the data item was not previously added to the virtual dataset.

The manifest file for the virtual dataset is updated at 618. According to various embodiments, the manifest file may identify various components included within a virtual dataset, such as the individual changesets. Accordingly, updating the manifest file may include, for instance, adding a reference to the newly created changeset to the manifest file.

In particular embodiments, the operations shown in FIG. 6 may be performed in an order different than that shown. For example, one or more operations may be performed in parallel. As another example, data items may be stored at 616 prior to creating the changeset at 612.

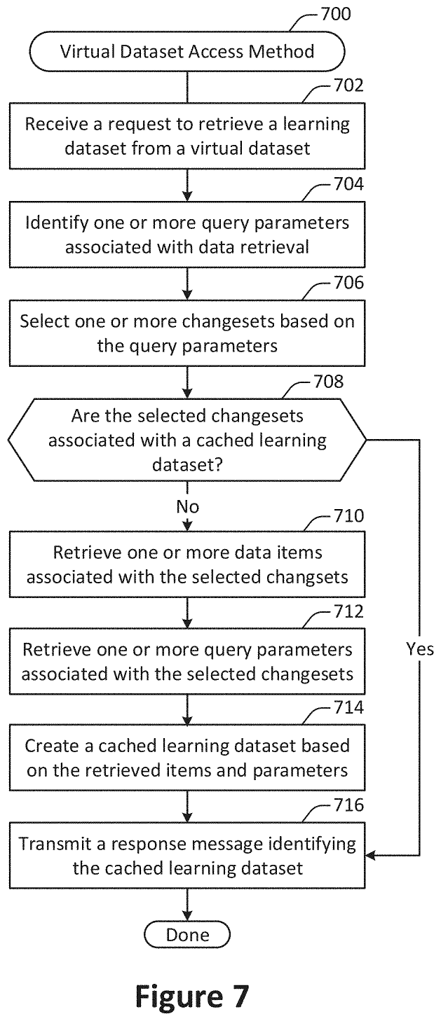

FIG. 7 illustrates an example of a virtual dataset access method, performed in accordance with one or more embodiments. According to various embodiments, the method 500 may be performed within an on-demand computing services environment such as the environments 810 and 900 shown in FIG. 8, FIG. 9A, and FIG. 9B.

A request to retrieve a learning dataset from a virtual dataset is received at 702. In some implementations, the request may be received via an API. The request may include an identifier for the virtual dataset.

One or more query parameters associated with data retrieval are identified at 704. One or more changesets are selected at 706 based on the query parameters. According to various embodiments, one or more query parameters may be included with the request received as 702. For instance, a query parameter may be included as a parameter in an API call. Alternatively, or additionally, one or more query parameters may be included in configuration information associated with a user, organization, or virtual dataset.

In some implementations, a query parameter may indicate a characteristic of a changeset. For example, a query parameter may be used to select all changesets that were created after a particular date. As another example, a query parameter may be used to select all changesets in a designated list. As yet another example, a query parameter may be used to select all changesets having labels corresponding to one or more filters.

In some embodiments, a query parameter may indicate a characteristic associated with data retrieval. For instance, a query parameter may specify a percentage of data associated with the selected changesets to retrieve.

A determination is made at 708 as to whether the selected changesets are associated with a cached learning dataset. The determination may be made at least in part by comparing the list of changesets selected at 706 to the entries in the learning dataset cache 304 discussed with respect to FIG. 3. Using the example shown in FIG. 4, cached learning datasets have been created for changesets [tm1, tm2], [tm1, tm2, tm3], and [tm1, tm4]. In this example, if one of these lists of changesets were selected, then a new cached version need not be created. However, if the list of selected changesets instead included [tm1, tm2, tm4], then a new cached learning dataset may be created.

When it is determined that a cached learning dataset is not available, then at 720 one or more data items associated with the selected changesets are retrieved. In some embodiments, retrieving the one or more data items may involve accessing the current dataset views associated with the changesets and retrieving data items from the datastore based on those references.

At 712, one or more query parameters associated with the selected changesets are retrieved. In some implementations, retrieving the one or more query parameters may involve accessing each changeset to identify any queries associated with each changeset.

In particular embodiments, retrieved query parameters may be aggregated. For instance, if one changeset is associated with a query of a remote datastore in which data items matching the label “tm5” are retrieved and if another changeset is associated with a query of the same remote datastore in which data items matching the label “tm6” are retrieved, then these query parameters may be combined into a single query of the remote datastore in which all data items matching the label “tm5 OR tm6” are retrieved.

A cached learning dataset is created at 714 based on the retrieved items and parameters. In some implementations, creating the cached learning dataset may involve aggregating the retrieved items and parameters in an archive file such as a zip file or tar file. In particular embodiments, a compression algorithm may be applied to the aggregated data. In general, a singular file may provide for easier access and greater simplicity. However, in some configurations more than one file may be used. The learning dataset may be stored in the learning dataset cache after it is created.

In particular embodiments, each cached learning dataset may be associated with an identifier. For example, a random identifier may be used. As another example, the identifier may be based on the query parameters. For instance, the identifier may be a hashed version of the changesets included in the cached learning dataset or of the query parameters themselves.

In particular embodiments, a cached learning dataset eventually may be deleted from the cache. Various deletion criteria may be used. For example, each cached learning dataset may be associated with a time period after which the cached learning dataset is deleted. As another example, the system may be configured to store a designated number of cached learning datasets for a virtual dataset. Then, when the number of cached learning datasets reaches the threshold, the oldest cached learning dataset may be deleted.

A response message identifying the cached learning dataset is transmitted at 716. In some embodiments, transmitting the cached learning dataset may involve sending a response message via an API. The response message may include an address for accessing the cached learning dataset. Alternatively, in some configurations the response message may include the cached learning dataset itself.

In particular embodiments, the operations shown in FIG. 7, and indeed in flow charts throughout the application, may be performed in an order different than that shown. For instance, one or more query parameters may be retrieved at 714 prior to, or in parallel with, the retrieval of one or more data items at 710.

In particular embodiments, one or more operations shown in FIG. 7, and indeed in flow charts throughout the application, may be omitted. For example, if the changesets selected at 706 lack queries or references to external datastores, then operation 712 may be omitted. As another example, if the changesets selected at 706 lack individual data items and instead include only queries, then operation 710 may be omitted.

FIG. 8 shows a block diagram of an example of an environment 810 that includes an on-demand database service configured in accordance with some implementations. Environment 810 may include user systems 812, network 814, database system 816, processor system 817, application platform 818, network interface 820, tenant data storage 822, tenant data 823, system data storage 824, system data 825, program code 826, process space 828, User Interface (UI) 830, Application Program Interface (API) 832, PL/SOQL 834, save routines 836, application setup mechanism 838, application servers 850-1 through 850-N, system process space 852, tenant process spaces 854, tenant management process space 860, tenant storage space 862, user storage 864, and application metadata 866. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 816, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 818 may be a framework that allows the creation, management, and execution of applications in system 816. Such applications may be developed by the database service provider or by users or third-party application developers accessing the service. Application platform 818 includes an application setup mechanism 838 that supports application developers' creation and management of applications, which may be saved as metadata into tenant data storage 822 by save routines 836 for execution by subscribers as one or more tenant process spaces 854 managed by tenant management process 860 for example. Invocations to such applications may be coded using PL/SOQL 834 that provides a programming language style interface extension to API 832. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 866 for a subscriber making such an invocation. Such system processes may also manage execution of application metadata 866 as an application in a virtual machine.

In some implementations, each application server 850 may handle requests for any user associated with any organization. A load balancing function (e.g., an F5 Big-IP load balancer) may distribute requests to the application servers 850 based on an algorithm such as least-connections, round robin, observed response time, etc. Each application server 850 may be configured to communicate with tenant data storage 822 and the tenant data 823 therein, and system data storage 824 and the system data 825 therein to serve requests of user systems 812. The tenant data 823 may be divided into individual tenant storage spaces 862, which can be either a physical arrangement and/or a logical arrangement of data. Within each tenant storage space 862, user storage 864 and application metadata 866 may be similarly allocated for each user. For example, a copy of a user's most recently used (MRU) items might be stored to user storage 864. Similarly, a copy of MRU items for an entire tenant organization may be stored to tenant storage space 862. A UI 830 provides a user interface and an API 832 provides an application programming interface to system 816 resident processes to users and/or developers at user systems 812.

System 816 may implement a web-based virtual dataset management system. For example, in some implementations, system 816 may include application servers configured to implement and execute virtual dataset management software applications. The application servers may be configured to provide related data, code, forms, web pages and other information to and from user systems 812. Additionally, the application servers may be configured to store information to, and retrieve information from a database system. Such information may include related data, objects, and/or Webpage content. With a multi-tenant system, data for multiple tenants may be stored in the same physical database object in tenant data storage 822, however, tenant data may be arranged in the storage medium(s) of tenant data storage 822 so that data of one tenant is kept logically separate from that of other tenants. In such a scheme, one tenant may not access another tenant's data, unless such data is expressly shared.

Several elements in the system shown in FIG. 8 include conventional, well-known elements that are explained only briefly here. For example, user system 812 may include processor system 812A, memory system 812B, input system 812C, and output system 812D. A user system 812 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 812 to access, process and view information, pages and applications available from system 816 over network 814. Network 814 may be any network or combination of networks of devices that communicate with one another, such as any one or any combination of a LAN (local area network), WAN (wide area network), wireless network, or other appropriate configuration.

The users of user systems 812 may differ in their respective capacities, and the capacity of a particular user system 812 to access information may be determined at least in part by “permissions” of the particular user system 812. As discussed herein, permissions generally govern access to computing resources such as data objects, components, and other entities of a computing system, such as a virtual dataset management system, a social networking system, and/or a CRM database system. “Permission sets” generally refer to groups of permissions that may be assigned to users of such a computing environment. For instance, the assignments of users and permission sets may be stored in one or more databases of System 816. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 816 may provide on-demand database service to user systems 812 using an MTS arrangement. By way of example, one tenant organization may be a company that employs a sales force where each salesperson uses system 816 to manage their sales process. Thus, a user in such an organization may maintain contact data, leads data, customer follow-up data, performance data, goals and progress data, etc., all applicable to that user's personal sales process (e.g., in tenant data storage 822). In this arrangement, a user may manage his or her sales efforts and cycles from a variety of devices, since relevant data and applications to interact with (e.g., access, view, modify, report, transmit, calculate, etc.) such data may be maintained and accessed by any user system 812 having network access.

When implemented in an MTS arrangement, system 816 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 816 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 816 may also maintain system-level data usable by multiple tenants or other data. Such system-level data may include industry reports, news, postings, and the like that are sharable between tenant organizations.

In some implementations, user systems 812 may be client systems communicating with application servers 850 to request and update system-level and tenant-level data from system 816. By way of example, user systems 812 may send one or more queries requesting data of a database maintained in tenant data storage 822 and/or system data storage 824. An application server 850 of system 816 may automatically generate one or more SQL statements (e.g., one or more SQL queries) that are designed to access the requested data. System data storage 824 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For virtual dataset management systems, entity tables may be configured to store standard entities such as text, image, or video data for machine learning applications. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 9A shows a system diagram of an example of architectural components of an on-demand database service environment 900, configured in accordance with some implementations. A client machine located in the cloud 904 may communicate with the on-demand database service environment via one or more edge routers 908 and 912. A client machine may include any of the examples of user systems 812 described above. The edge routers 908 and 912 may communicate with one or more core switches 920 and 924 via firewall 916. The core switches may communicate with a load balancer 928, which may distribute server load over different pods, such as the pods 940 and 944 by communication via pod switches 932 and 936. The pods 940 and 944, which may each include one or more servers and/or other computing resources, may perform data processing and other operations used to provide on-demand services. Components of the environment may communicate with a database storage 956 via a database firewall 948 and a database switch 952.

Accessing an on-demand database service environment may involve communications transmitted among a variety of different components. The environment 900 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 9A and 9B.

The cloud 904 refers to any suitable data network or combination of data networks, which may include the Internet. Client machines located in the cloud 904 may communicate with the on-demand database service environment 900 to access services provided by the on-demand database service environment 900. By way of example, client machines may access the on-demand database service environment 900 to retrieve, store, edit, and/or process virtual dataset information.

In some implementations, the edge routers 908 and 912 route packets between the cloud 904 and other components of the on-demand database service environment 900. The edge routers 908 and 912 may employ the Border Gateway Protocol (BGP). The edge routers 908 and 912 may maintain a table of IP networks or ‘prefixes’, which designate network reachability among autonomous systems on the internet.

In one or more implementations, the firewall 916 may protect the inner components of the environment 900 from internet traffic. The firewall 916 may block, permit, or deny access to the inner components of the on-demand database service environment 900 based upon a set of rules and/or other criteria. The firewall 916 may act as one or more of a packet filter, an application gateway, a stateful filter, a proxy server, or any other type of firewall.

In some implementations, the core switches 920 and 924 may be high-capacity switches that transfer packets within the environment 900. The core switches 920 and 924 may be configured as network bridges that quickly route data between different components within the on-demand database service environment. The use of two or more core switches 920 and 924 may provide redundancy and/or reduced latency.

In some implementations, communication between the pods 940 and 944 may be conducted via the pod switches 932 and 936. The pod switches 932 and 936 may facilitate communication between the pods 940 and 944 and client machines, for example via core switches 920 and 924. Also or alternatively, the pod switches 932 and 936 may facilitate communication between the pods 940 and 944 and the database storage 956. The load balancer 928 may distribute workload between the pods, which may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948, which may act as a computer application firewall operating at the database application layer of a protocol stack. The database firewall 948 may protect the database storage 956 from application attacks such as structure query language (SQL) injection, database rootkits, and unauthorized information disclosure. The database firewall 948 may include a host using one or more forms of reverse proxy services to proxy traffic before passing it to a gateway router and/or may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, the database storage 956 may be an on-demand database system shared by many different organizations. The on-demand database service may employ a single-tenant approach, a multi-tenant approach, a virtualized approach, or any other type of database approach. Communication with the database storage 956 may be conducted via the database switch 952. The database storage 956 may include various software components for handling database queries. Accordingly, the database switch 952 may direct database queries transmitted by other components of the environment (e.g., the pods 940 and 944) to the correct components within the database storage 956.

FIG. 9B shows a system diagram further illustrating an example of architectural components of an on-demand database service environment, in accordance with some implementations. The pod 944 may be used to render services to user(s) of the on-demand database service environment 900. The pod 944 may include one or more content batch servers 964, content search servers 968, query servers 982, file servers 986, access control system (ACS) servers 980, batch servers 984, and app servers 988. Also, the pod 944 may include database instances 990, quick file systems (QFS) 992, and indexers 994. Some or all communication between the servers in the pod 944 may be transmitted via the switch 936.

In some implementations, the app servers 988 may include a framework dedicated to the execution of procedures (e.g., programs, routines, scripts) for supporting the construction of applications provided by the on-demand database service environment 900 via the pod 944. One or more instances of the app server 988 may be configured to execute all or a portion of the operations of the services described herein.

In some implementations, as discussed above, the pod 944 may include one or more database instances 990. A database instance 990 may be configured as an MTS in which different organizations share access to the same database, using the techniques described above. Database information may be transmitted to the indexer 994, which may provide an index of information available in the database 990 to file servers 986. The QFS 992 or other suitable filesystem may serve as a rapid-access file system for storing and accessing information available within the pod 944. The QFS 992 may support volume management capabilities, allowing many disks to be grouped together into a file system. The QFS 992 may communicate with the database instances 990, content search servers 968 and/or indexers 994 to identify, retrieve, move, and/or update data stored in the network file systems (NFS) 996 and/or other storage systems.

In some implementations, one or more query servers 982 may communicate with the NFS 996 to retrieve and/or update information stored outside of the pod 944. The NFS 996 may allow servers located in the pod 944 to access information over a network in a manner similar to how local storage is accessed. Queries from the query servers 922 may be transmitted to the NFS 996 via the load balancer 928, which may distribute resource requests over various resources available in the on-demand database service environment 900. The NFS 996 may also communicate with the QFS 992 to update the information stored on the NFS 996 and/or to provide information to the QFS 992 for use by servers located within the pod 944.

In some implementations, the content batch servers 964 may handle requests internal to the pod 944. These requests may be long-running and/or not tied to a particular customer, such as requests related to log mining, cleanup work, and maintenance tasks. The content search servers 968 may provide query and indexer functions such as functions allowing users to search through content stored in the on-demand database service environment 900. The file servers 986 may manage requests for information stored in the file storage 998, which may store information such as documents, images, basic large objects (BLOBs), etc. The query servers 982 may be used to retrieve information from one or more file systems. For example, the query system 982 may receive requests for information from the app servers 988 and then transmit information queries to the NFS 996 located outside the pod 944. The ACS servers 980 may control access to data, hardware resources, or software resources called upon to render services provided by the pod 944. The batch servers 984 may process batch jobs, which are used to run tasks at specified times. Thus, the batch servers 984 may transmit instructions to other servers, such as the app servers 988, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

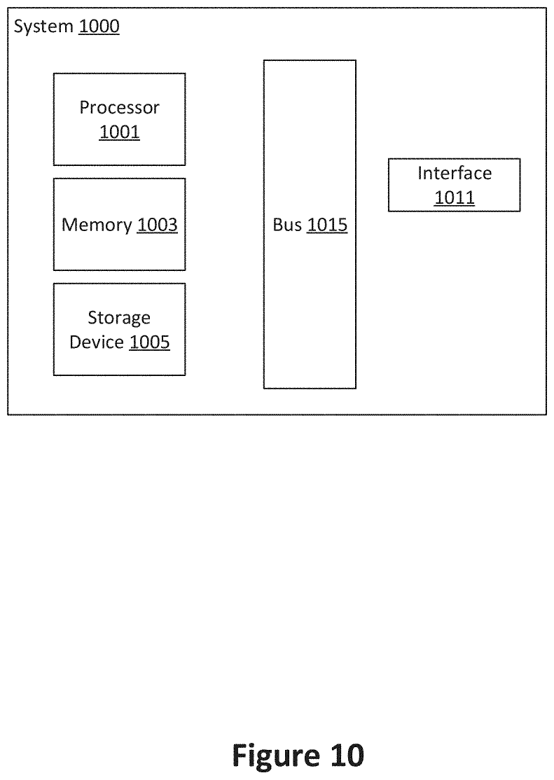

FIG. 10 illustrates one example of a computing device. According to various embodiments, a system 1000 suitable for implementing embodiments described herein includes a processor 1001, a memory module 1003, a storage device 1005, an interface 1011, and a bus 1015 (e.g., a PCI bus or other interconnection fabric.) System 1000 may operate as variety of devices such as an application server, a database server, or any other device or service described herein. Although a particular configuration is described, a variety of alternative configurations are possible. The processor 1001 may perform operations such as those described herein. Instructions for performing such operations may be embodied in the memory 1003, on one or more non-transitory computer readable media, or on some other storage device. Various specially configured devices can also be used in place of or in addition to the processor 1001. The interface 1011 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A computer-implemented method implemented in a database system, the method comprising:
receiving a request from a remote computing device via a communication interface to access a virtual dataset, the request identifying one or more changeset selection criteria;
selecting one or more of a plurality of changesets in the virtual dataset based on the changeset selection criteria, each changeset corresponding with a respective point in time, each changeset including a respective plurality of data references, each data reference identifying a respective data item added to the virtual dataset at the respective point in time corresponding with the changeset;
identifying a designated learning dataset that includes a designated plurality of data items, each of the designated plurality of data items being associated with a respective label, each of the designated plurality of data items being referenced by one or more of the selected changesets; and
transmitting a response message to the remote computing device, the response message providing access to the identified learning dataset.

2. The computer-implemented method recited in claim 1, wherein the changeset selection criteria include a designated date range, and wherein the respective points in time corresponding with the selected changesets fall within the designated date range.

3. The computer-implemented method recited in claim 1, wherein the changeset selection criteria include a designated one or more data item labels, and wherein each of the selected changesets includes one or more data references identifying a respective data item associated with one of the designated one or more data item labels.

4. The computer-implemented method recited in claim 1, wherein one or more of the data items comprises a remote datastore query, the remote datastore query including one or more parameters for retrieving a respective one or more data items from a remote datastore accessible via the internet.

5. The computer-implemented method recited in claim 1, wherein providing access to the identified learning dataset involves transmitting the learning dataset to a remote data analytics platform, the remote data analytics platform being separate from the remote computing device.

6. The computer-implemented method recited in claim 5, wherein the remote computing device lacks permission to directly access to the identified learning dataset.

7. The computer-implemented method recited in claim 1, wherein the method further comprises:
accessing a learning dataset cache to determine whether the learning dataset cache includes the designated learning dataset.

8. The computer-implemented method recited in claim 7, wherein identifying the designated learning dataset comprises identifying an identifier with a cached learning dataset when it is determined that the learning dataset cache includes the designated learning dataset.

9. The computer-implemented method recited in claim 7, wherein identifying the designated learning dataset comprises creating the designated learning dataset and storing the designated learning dataset in the learning dataset cache when it is determined that the learning dataset cache does not include the designated learning dataset.

10. The computer-implemented method recited in claim 1, wherein the request is received via an Application Procedure Interface (API) call that includes an identifier associated with the virtual dataset.

11. The computer-implemented method recited in claim 10, wherein the API is a representational state transfer (REST) interface that includes functions for adding data items to the virtual dataset to create a new changeset, for creating the identified learning dataset, and for accessing the identified learning dataset.

12. The computer-implemented method recited in claim 10, wherein access to the identified designated learning dataset is provided by transmitting a uniform resource locator (URL) to a file in the response message, the response message being transmitted via the API.

13. The computer-implemented method recited in claim 1, wherein the storage system is located within an on-demand computing services environment configured to provide computing services to a plurality of organizations via the internet, and wherein access to the designated learning dataset is provided as a service via the internet.

14. The computer-implemented method recited in claim 13, wherein the data items are stored in a multi-tenant database, each of the organizations corresponding to a respective tenant within the multi-tenant database, access to the virtual dataset being limited to a respective one of the organizations.

15. A database system configured to perform a method, the method comprising:
receiving a request from a remote computing device via a communication interface to access a virtual dataset, the request identifying one or more changeset selection criteria;
selecting one or more of a plurality of changesets in the virtual dataset based on the changeset selection criteria, each changeset corresponding with a respective point in time, each changeset including a respective plurality of data references, each data reference identifying a respective data item added to the virtual dataset at the respective point in time corresponding with the changeset;
identifying a designated learning dataset that includes a designated plurality of data items, each of the designated plurality of data items being associated with a respective label, each of the designated plurality of data items being referenced by one or more of the selected changesets; and
transmitting a response message to the remote computing device, the response message providing access to the identified learning dataset.

16. The database system recited in claim 15, wherein the changeset selection criteria include a designated date range, and wherein the respective points in time corresponding with the selected changesets fall within the designated date range.

17. The database system recited in claim 15, wherein the changeset selection criteria include a designated one or more data item labels, and wherein each of the selected changesets includes one or more data references identifying a respective data item associated with one of the designated one or more data item labels.

18. The database system recited in claim 15, wherein one or more of the data items comprises a remote datastore query, the remote datastore query including one or more parameters for retrieving a respective one or more data items from a remote datastore accessible via the internet.

19. The database system recited in claim 15, wherein providing access to the identified learning dataset involves transmitting the learning dataset to a remote data analytics platform, the remote data analytics platform being separate from the remote computing device.

20. One or more non-transitory computer readable media having instructions stored thereon for performing a method, the method comprising:
receiving a request from a remote computing device via a communication interface to access a virtual dataset, the request identifying one or more changeset selection criteria;
selecting one or more of a plurality of changesets in the virtual dataset based on the changeset selection criteria, each changeset corresponding with a respective point in time, each changeset including a respective plurality of data references, each data reference identifying a respective data item added to the virtual dataset at the respective point in time corresponding with the changeset;
identifying a designated learning dataset that includes a designated plurality of data items, each of the designated plurality of data items being associated with a respective label, each of the designated plurality of data items being referenced by one or more of the selected changesets; and
transmitting a response message to the remote computing device, the response message providing access to the identified learning dataset.
